(19) United States
(12) Patent Application Publication
(10) Pub. No.: US 2011/0064341 A1
(43) Pub. Date: Mar. 17, 2011

(54) DISK DRIVE DEVICE CAPABLE OF BEING IMPROVED IN ANTI-VIBRATION CHARACTERISTIC

(75) Inventors: Masafumi MIZUNO, Shizuoka (JP); Mitsuo KODAMA, Shizuoka (JP); Hiroshi IWAI, Shizuoka (JP)

(73) Assignee: Alphana Technology Co., Ltd., Shizuoka (JP)

(21) Appl. No.: 12/842,877

(22) Filed: Jul. 23, 2010

(30) Foreign Application Priority Data
Sep. 14, 2009 (JP) 2009-211263

(51) Int. Cl. G11B 17/02; F16C 32/06; B26D 1/00; H04R 17/00; B23B 3/00

(52) U.S. Cl. 384/114; 83/13; 29/25.35; 82/1.11; 360/99.08; G9B/17.002

(57) ABSTRACT

A disk drive device includes: a hub on which a recording disk is to be mounted; a shaft; a sleeve configured to house the shaft and to be rotatable relatively with respect to the shaft; a radial space portion formed between the inner circumferential surface of the sleeve and the outer circumferential surface of the shaft; a radial dynamic pressure generating portion configured to generate radial dynamic pressure between at least part of the inner circumferential surface of the sleeve and the outer circumferential surface of the shaft in the radial space portion; and lubricant. The axial length of the radial dynamic pressure generating portion is formed to be longer than the diameter of the radial dynamic pressure generating portion such that radial dynamic pressure, which is defined with the axial length of the radial dynamic pressure generating portion and the diameter thereof being parameters, is greater than or equal to a predetermined minimum reference value.

### BACKGROUND OF THE INVENTION

1. Field of the Invention

The present invention relates to a disk drive device, in particular, to a disk drive device capable of being improved in anti-vibration characteristic while reducing a drive current.

2. Description of the Related Art

In recent years, disk drive devices, such as Hard Disk Drives (HDDs), have been developed to be small in size and large in capacity, and been widely used in many electrical appliances. Therefore, disk drive devices have been used in a wide variety of environments. In particular, the disk drive devices are being mounted in portable devices called mobile devices. Mobile devices are frequently used in environments with a lot of vibrations, and therefore the disk drive devices to be mounted in the mobile devices are demanded to have characteristics in which read/write of data can be stably performed even when used in an environment with a lot of vibrations. In order to meet such a demand, there is a disk driver device in which a fluid dynamic bearing capable of stably rotating at high-speed is mounted. For example, Japanese Patent Application Publication No. 2007-198555 discloses an example of the structure of a fluid dynamic bearing unit, in which lubricant is injected into the space between a sleeve of which part of a stator is composed and a shaft of which part of a rotating body is composed. In this fluid dynamic bearing, smooth high-speed rotation of the rotating body can be realized by supporting the rotating body in a non-contact state with dynamic pressure generated in part of the lubricant.

Because miniaturization of mobile devices is considered to be important, batteries for mobile devices are often made small with this. As a result, it is often demanded that a drive current should be reduced when a disk drive device is to be mounted in a mobile device. If a drive current in a disk drive device is reduced, the dynamic pressure to be generated by a fluid dynamic bearing unit is decreased accordingly, resulting in decreased bearing stiffness of the fluid dynamic bearing unit. If the bearing stiffness of a fluid dynamic bearing unit is decreased, an axial displacement of a rotating body including a recording disk becomes large when the disk drive device has vibrated after receiving an impact, etc. If a displacement of a recording disk becomes large, the relative distance between the recording disk and a magnetic head becomes unstable, thereby causing the problem that an increase in errors in reading/writing data may be incurred.

### SUMMARY OF THE INVENTION

The present invention has been made in view of these situations, and a purpose of the invention is to provide a disk drive device in which, even if a drive current is reduced, the bearing stiffness of a fluid dynamic bearing unit is maintained and therefore read/write of data can be stably performed even under an environment with a lot of vibrations.

In order to solve the aforementioned problem, a disk drive device according to an embodiment of the present invention comprises: a hub on which a recording disk is to be mounted; a shaft to be the rotational center of the hub; a sleeve configured to house the shaft and to be rotatable relatively with respect to the shaft; a radial space portion formed between the inner circumferential surface of the sleeve and the outer circumferential surface of the shaft; a radial dynamic pressure generating portion configured to generate radial dynamic pressure between at least part of the inner circumferential surface of the sleeve and the outer circumferential surface of the shaft in the radial space portion; and lubricant injected into the radial dynamic pressure generating portion. The axial length of the radial dynamic pressure generating portion is structured to be longer than the diameter of the radial dynamic pressure generating portion such that radial dynamic pressure, which is defined with the axial length of the radial dynamic pressure generating portion and the diameter thereof being parameters, is greater than or equal to a predetermined minimum reference value.

According to this embodiment, the relationship between the axial length of the radial dynamic pressure generating portion and the diameter thereof is defined such that the radial dynamic pressure to be generated in the radial dynamic pressure generating portion is greater than or equal to a predetermined design minimum reference value. For example, when the diameter of the radial dynamic pressure generating portion is made small, the diameter of the shaft itself, which is to be housed, is made small accordingly. As a result, the circumferential formation length of the radial dynamic pressure generating portion becomes short. That is, when relative rotation occurs between the shaft and the sleeve, the resistance to the lubricant in the radial space portion is reduced. As a result, a driving force for rotating, in the radial space portion, the hub and the shaft on which a recording disk is mounted, i.e., a drive current can be reduced. Further, the weight of the shaft is reduced by making the diameter thereof small, which can contribute to a reduction in a drive current. On the other hand, the total area of the radial dynamic pressure generating portion is substantially decreased due to the decrease in the circumferential formation length accompanying the reduction in the diameter of the radial dynamic pressure generating portion, and therefore the generation amount of the radial dynamic pressure is decreased. Then, a generation amount of the radial dynamic pressure as a whole is made greater than or equal to the minimum reference value by making the axial length of the radial dynamic pressure generating portion to increase the total area thereof. By making the axial length of the radial dynamic pressure generating portion longer than the diameter thereof as stated above, a generation amount of the radial dynamic pressure can be maintained or improved while reducing a drive current.

Another embodiment of the present invention is also a disk drive device. This device comprises: a hub on which a recording disk is to be mounted; a shaft to be the rotational center of the hub; a sleeve configured to house the shaft and to be rotatable relatively with respect to the shaft; a radial space portion formed between the inner circumferential surface of the sleeve and the outer circumferential surface of the shaft; a radial dynamic pressure generating portion configured to generate radial dynamic pressure between at least part of the inner circumferential surface of the sleeve and the outer circumferential surface of the shaft in the radial space portion; and lubricant injected into the radial dynamic pressure generating portion. The radial dynamic pressure generating portion is composed of a plurality of striped groove portions repeatedly arranged along the rotational direction. Each of the striped groove portions is formed by end portions on both side and an intermediate portion sandwiched by the end portions on both sides, and the end portions on both sides and the intermediate portion are arranged such that the lubricant is collected into the intermediate portion by the relative rotation between the shaft and the sleeve, and the width in the rotational direction of the intermediate portion in the striped groove portion is structured to be narrower than that in the rotational direction of each of the end portions on both sides.

By making the width in the rotational direction of the intermediate portion in a striped groove portion narrower than that in the rotational direction of each of the end portions on both sides, it becomes possible that an amount of lubricant, which is larger than that acceptable with the intermediate portion, can be scraped up from the end portions to be transferred into the intermediate portion, thereby allowing for radial dynamic pressure to be efficiently increased.

### BRIEF DESCRIPTION OF THE DRAWINGS

Embodiments will now be described, by way of example only, with reference to the accompanying drawings, which are meant to be exemplary, not limiting, and wherein like elements are numbered alike in several figures, in which:

FIG. 1 is an illustrative view illustrating the internal structure of an HDD, which is an example of a disk drive device according to the present embodiment;

FIG. 2 is a schematic cross-sectional view of a brushless motor in the disk drive device according to the present embodiment;

FIG. 3 is an illustrative view illustrating the basic shape in the shapes of a striped groove portion in a radial dynamic pressure generating portion in the disk drive device according to the present embodiment;

FIG. 4 is a partial cross-sectional view illustrating the relationship between the diameter of the radial dynamic pressure generating portion and the length thereof in the radial dynamic pressure generating portion in the disk drive device according to the present embodiment;

FIG. 5 is a cross-sectional view of a hub, illustrating processing procedure of the hub in the disk drive device according to the present embodiment;

FIG. 6A is an illustrative view illustrating a shape of the striped groove portion in the radial dynamic pressure generating portion in the disk drive device according to the present embodiment, the shape being a variation of the basic shape of FIG. 3;

FIG. 6B is an illustrative view illustrating a shape of the striped groove portion in the radial dynamic pressure generating portion in the disk drive device according to the present embodiment, the shape being a variation of the basic shape of FIG. 3;

FIG. 6C is an illustrative view illustrating a shape of the striped groove portion in the radial dynamic pressure generating portion in the disk drive device according to the present embodiment, the shape being a variation of the basic shape of FIG. 3; and

FIG. 7 is a schematic cross-sectional view illustrating an example of another structure of the brushless motor in the disk drive device according to the present embodiment.

### DETAILED DESCRIPTION OF THE INVENTION

The invention will now be described by reference to the preferred embodiments. This does not intend to limit the scope of the present invention, but to exemplify the invention.

Hereinafter, preferred embodiments of the present invention will be described based on the accompanying drawings. The present embodiment can be adopted in a brushless motor, which is mounted in a Hard Disk Drive device (sometimes, simply referred to as an HDD or a disk drive device) to drive a recording disk, or adopted in a disk drive motor to be mounted in an optical disk recording and reproducing device, such as a CD (Compact Disc) device and a DVD (Digital Versatile Disc) device.

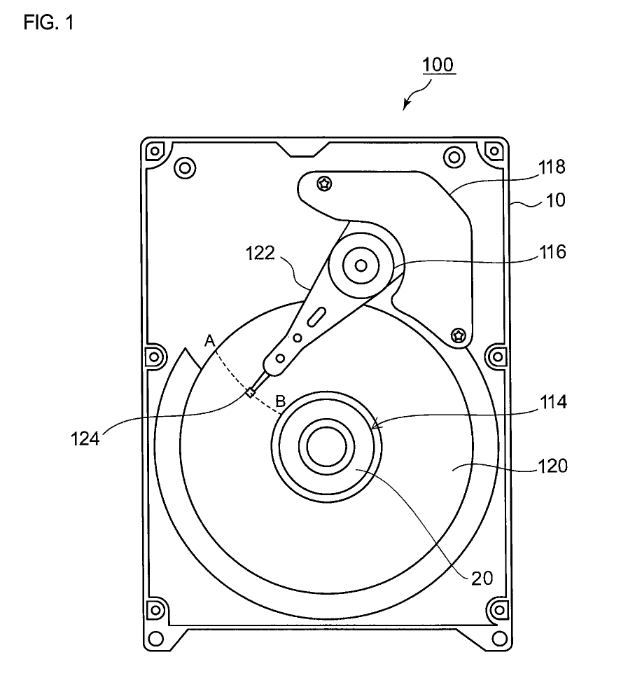

FIG. 1 is an illustrative view illustrating the internal structure of an HDD 100 (hereinafter, referred to as a disk drive device 100), which is an example of a disk drive device according to the present embodiment. FIG. 1 illustrates the state where a cover is removed to expose the internal structure.

A brushless motor 114, an arm bearing unit 116, and a voice coil motor 118, etc., are mounted on the upper surface of a base member 10. The brushless motor 114 supports, on the rotation axis, a hub 20 on which a recording disk 120 is to be mounted and rotationally drives the recording disk 120 on which data can be recorded, for example, magnetically. The brushless motor 114 can be replaced with, for example, a spindle motor. The brushless motor 114 is driven by a three-phase drive current consisting of a U-phase, a V-phase, and a W-phase. The arm bearing unit 116 supports a swing arm 122 within the movable range AB and in a swing-free manner. The voice coil motor 118 makes the swing arm 122 swing in accordance with external control data. A magnetic head 124 is fixed to the tip of the swing arm 122. When the disk drive device 100 is in an operating state, the magnetic head 124 moves, with the swing of the swing arm 122, within the movable range AB and above the surface of the recording disk 120 via a slight gap between the surface of the recording disk 120 and the magnet head 124, thereby performing read/write of data. It is noted that, in FIG. 1, the point A corresponds to the position at the outermost recording track of the recording disk 120 and the point B to the position at the innermost recording track thereof. The swing arm 122 may be transferred to a waiting position provided on the side of the recording disk 120 when the disk drive device 100 is in a stopped state.

In the present embodiment, a device including all of the components for reading/writing data, such as the recording disk 120, the swing arm 122, the magnetic head 124, and voice coil motor 118, etc., is sometimes expressed as a disk drive device, or as an HDD. Alternatively, only the part for rotationally driving the recording disk 120 is sometimes expressed as a disk drive device.

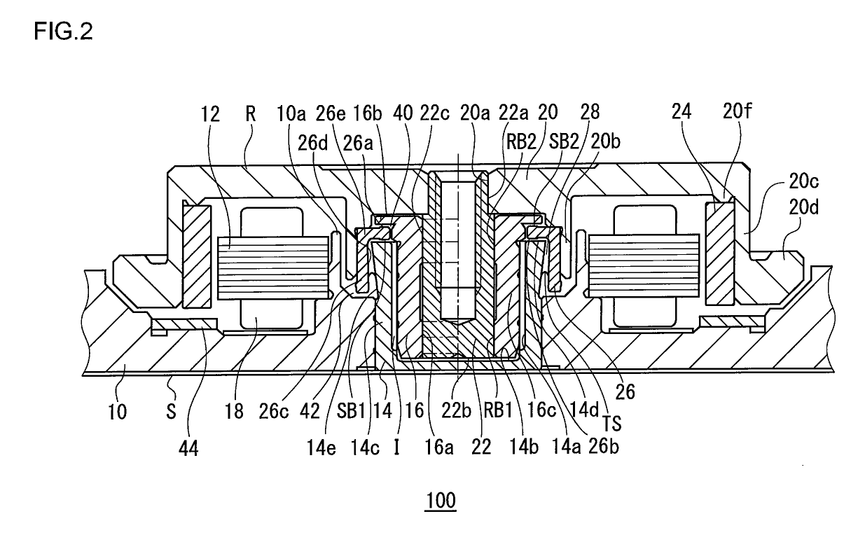

FIG. 2 is a schematic cross-sectional view of the brushless motor in the disk drive device 100 according to the present embodiment, the view being taken along the axial direction of a shaft 22 in the disk drive device 100. The disk drive device 100 comprises a fixed body S and a rotating body R. The fixed body S includes the base member 10, a stator core 12, a housing 14, and a sleeve 16. The rotating body R includes the hub 20, the shaft 22, and a thrust member 26. The base member 10 includes a cylinder portion 10a and the housing 14 includes a groove portion 14a, a bottom 14b, a cylinder portion 14c, and a housing flat portion 14d. The sleeve 16 includes a cylinder portion inner circumferential surface 16a, a circumferentially-protruding portion 16b, and a cylinder portion 16c, and a coil 18 is wound around the stator core 12. The hub 20 includes a center hole 20a, a first cylinder portion 20b, a second cylinder portion 20c, a hub outward extending portion 20d, and a pedestal portion 20f. The shaft 22 includes a step portion 22a, a tip portion 22b, and an outer circumferential surface 22c; and the thrust member 26 includes a hanging portion 26c and a flange 26e. It is noted that, in the following descriptions, for convenience, the downward direction illustrated in the drawings is expressed as the bottom and the upward direction illustrated therein as the top, as a whole.

The base member 10 has a central hole and the cylinder portion 10a provided so as to surround the central hole. The base member 10 holds the housing 14 with the central hole and fixes the stator core 12 to the outer circumference of the cylinder portion 10a surrounding the housing 14. An annular-shaped second area portion 42 is formed between the outer circumference of the housing 14 and the inner circumference of the cylinder portion 10a. The second area portion 42 has a shape surrounding the central hole of the base member 10. The base member 10 is formed by cutting an aluminum die casting product or pressing an aluminum plate or a nickel-plated steel plate.

The stator core 12 is formed by performing insulation coating made by electro-deposition coating or powder coating, etc., on the surface thereof after a plurality of magnetic plates, such as ferrosilicon plates, are laminated. The stator core 12 is a ring-shaped member having a plurality of salient poles (not illustrated) protruding outwards, around each of which the coil 18 is wound. When the disk drive device 100 is, for example, three-phase driven, the number of the salient poles is made to be nine. The wiring terminal of the coil 18 is soldered on an FPC (Flexible Printed Circuit) arranged on the bottom surface of the base member 10. The pulled-out wire terminal is fixed with adhesive so as not to unlay. The fixation is performed to prevent disconnection of the wire due to a vibration of large amplitude created by a resonance of the wire during ultrasonic wave cleaning, etc. When a three-phase current having an approximate sine wave shape is applied to the coil 18 through the FPC by a predetermined drive circuit, the coil 18 generates a rotating magnetic field in the salient poles of the stator core 12. A rotating drive force is generated by the interaction between the driving magnetic poles of the magnet 24 and the rotating magnetic field, which rotates the rotating body R.

An attracting plate 44 is fixed to a position on the base member 10 facing the axial lower end surface of the ring-shaped magnet 24 via a gap. The attracting plate 44 is a ring-shaped member and is formed by pressing a soft magnetic material, for example, a cold-rolled steel plate. The attracting plate 44 generates an axial magnetic attracting force between the magnet 24 and itself. That is, the attracting plate 44 generates a force to attract a hub in the direction where the rotating body R is drawn to the base member 10. The rotating body R is made to rotate in a non-contact state with surrounding members with three forces of a floating force, the force to attract the hub, and the gravity applied to the whole rotating body R, being balanced during the rotation of the rotating body R, the floating force being generated by a bearing including a radial dynamic pressure generating portion RB and a thrust dynamic pressure generating portion SB, which will be described later.

The housing 14 is fixed to the inner circumferential surface of the cylinder portion 10a by adhesion or press-fitting. The housing 14 is approximately cup-shaped, in which the cylinder portion 14c surrounding the sleeve 16, the housing flat portion 14d that is provided at the end portion nearer to the hub 20 and that has the surface facing in the axial direction, and the bottom 14b sealing the end portion of the cylinder portion 14c, the end portions being located on the side opposite to the housing flat portion 14d, are combined. The housing 14 having such a shape is arranged so as to seal the lower end of the sleeve 16 and to make the upper end thereof protrude. In addition, the bottom 14b and the cylinder portion 14c may be formed integrally with each other, or both may be fixed together after being formed as different members. The housing 14 may be formed of a copper-based alloy, a sintered alloy by powder metallurgy, stainless steel, or a plastic material, such as polyetherimide, polyimide, polyamide, etc. When the housing 14 is to be formed of a plastic material, it is desirable that the plastic material is structured by containing, for example, carbon fiber, etc., so that the specific resistance of the housing 14 is smaller than or equal to 10⁶ Ω·m in order to secure the static eliminating performance of the disk drive device 100.

A groove 14a extending in the axial direction is formed on the inner circumferential surface of the housing 14. The groove 14a functions as a communication hole for communicating both end surface sides of the housing 14 when the sleeve 16 is fit into the cylinder portion 14c. The communication hole becomes a communication channel I by being filled with lubricant 28. This communication channel I will be described later. The cross-sectional shape of the groove 14a may be a concave circular arc shape or a rectangular shape.

The sleeve 16 is fixed to the inner circumferential surface of the housing 14 by adhesion or press-fitting and is fixed on the same axis as that of the central hole of the base member 10. The sleeve 16 has a shape in which the annular cylinder portion 16c that supports the shaft 22 by housing the shaft 22 and a circumferentially-protruding portion 16b that is extended in the outer diameter direction at the end portion of the cylinder portion 16c, the end portion being located nearer to the hub 20, are combined. In addition, the cylinder portion inner circumferential surface 16a is formed inside the cylinder portion 16c so as to surround the shaft 22. A radial space portion is formed between the cylinder portion inner circumferential surface 16a of the sleeve 16 and the outer circumferential surface 22c of the shaft 22, and a first radial dynamic pressure generating portion RB1 and a second radial dynamic pressure generating portion RB2 are arranged in the radial space portion, as individual radial dynamic pressure generating portions for generating radial pressure in the radial space portion. The first radial dynamic pressure generating portion RB1 and the second radial dynamic pressure generating portion RB2 as individual radial dynamic pressure generating portions will be described later in detail. The circumferentially-protruding portion 16b and the cylinder portion 16c may be formed integrally with each other, or both may be fixed together after being formed as different members. An annular first area portion 40 is formed between the circumferentially-protruding portion 16b and the cylinder portion 14c. The sleeve 16 is formed of a copper-based alloy, a sintered alloy by powder metallurgy, stainless steel, etc. Other than that, the sleeve 16 may be formed of a plastic material, such as polyetherimide, polyimide, polyamide, etc. When the sleeve 16 is to be formed of a plastic material, it is desirable that the plastic material is structured by containing, for example, carbon fiber, etc., so that the specific resistance of the housing 14 is smaller than or equal to 10⁶ Ω·m in order to secure the static eliminating performance of the disk drive device 100.

The hub 20 is structured to include the center hole 20a provided at the center thereof, the first cylinder portion 20b provided so as to surround the center hole 20a, the second cylinder portion 20c arranged outside the first cylinder portion 20b, and the hub outward extending portion 20d extending outward in the radial direction at the lower end of the second cylinder portion 20c. The hub 20 is approximately cup-shaped. The hub 20 has soft magnetism. For example, the hub 20 is formed of a steel material, such as SUS 430F, etc. The hub 20 is formed to have an approximately cup-shaped predetermined shape by pressing or cutting a steel plate. For example, the stainless steel with the product name of DHS1, supplied by Daido Steel Co., Ltd., is preferred as a material for the hub 20 in terms of less outgassing and easy processing. Similarly, the stainless steel with the product name of DHS2 is more preferred as a material for the hub 20 in terms of good corrosion resistance in addition to the foregoing characteristics.

The thrust member 26 is fixed to the inner circumferential surface of the first cylinder portion 20b of the hub 20, and the magnet 24 is fixed to the inner circumferential surface of the second cylinder portion 20c. Herein, the magnet 24 is fixed to the annular portion that is concentric with the shaft 22 so as to face the stator core 12 fixed to the base member 10. With such a structure, the hub 20 rotates integrally with the shaft 22 to rotate the non-illustrated recording disk 120. The recording disk 120 is mounted on the hub outward extending portion 20d with the center hole of the recording disk 120 being engaged with the outer circumferential surface of the second cylinder portion 20c.

The shaft 22 is fixed to the center hole 20a of the hub 20. Herein, the step portion 22a is provided at the upper end portion of the shaft 22 and the shaft 22 is press-fit into the center hole 20a when assembled. As a result, the hub 20 is restricted in the axial movement by the step portion 22a and is integrated with the shaft 22 at a predetermined right angle. The tip 22b of the shaft 22 is housed within the inner circumference of the cylinder portion 16c. The shaft 22 can be formed of stainless steel.

The thrust member 26 has the flange 26e surrounding the sleeve 16 and the hanging portion 26c surrounding the housing 14. Herein, the flange 26e is fixed to the inner wall of the first cylinder portion 20b with adhesive and the hanging portion 26c is bound to the outer edge portion of the flange 26e and is also fixed to the inner wall of the first cylinder portion 20b with adhesive. That is, the outer circumferential surface of the hanging portion 26c is fixed to the inner circumferential surface of the first cylinder portion 20b by adhesion. Thus, the flange 26e surrounds the outer circumference of the cylinder portion 16c via a gap and is arranged above the lower surface of the circumferentially-protruding portion 16b via a narrow gap. In addition, while the thrust member 26 is rotating integrally with the hub 20, the flange 26e is rotating within the first area portion 40 and the hanging portion 26c is rotating within the second area portion 42.

As illustrated in FIG. 2, the flange 26e has a shape having a thrust upper surface 26a and a thrust lower surface 26b, the shape being thin in the axial direction. The hanging portion 26c extends in the axial direction from the lower surface nearer to the outer circumference of the flange 26e. A first thrust dynamic pressure generating portion SB1 is composed of the thrust lower surface 26b of the flange 26e and the housing flat portion 14d that is the upper end portion of the housing 14; and a second thrust dynamic pressure generating portion SB2 is composed of the thrust upper surface 26a of the flange 26e and the lower surface of the circumferentially-protruding portion 16b. The thrust member 26 is formed by combining the flange 26e with the hanging portion 26c and has a so-called inverted L-shaped cross section in which the alphabetical capital letter “L” is inverted upside down, as illustrated in FIG. 2. Herein, the axial length of the hanging portion 26c is larger than the axial length of the flange 26e. The inner circumferential surface 26d of the hanging portion 26c is tapered in which the radius thereof is reduced toward the side opposite to the side where the flange 26e is formed, thereby composing a capillary seal portion TS, which will be described later. Such a thrust member 26 can be easily and inexpensively formed by, for example, pressing a plate-shaped metal material. Further, the thrust member 26 can be formed with good dimension accuracy by press processing, etc., even if the thrust member 26 becomes small in size and thin. As a result, miniaturization and weight reduction of the disk drive device 100 can be attained by making the thrust member 26 small.

The thrust member 26 has the function of preventing the rotating body R from coming off the fixed body S other than composing the thrust dynamic pressure generating portion. If the rotating body R and the fixed body S are relatively transferred due to an impact, the flange 26e will be in contact with the lower surface of the circumferentially-protruding portion 16b. As a result, the thrust member 26 receives stress in the direction where the thrust member 26 will come off the first cylinder portion 20b. Because the bonding strength between the hanging portion 26c and the first cylinder portion 20b becomes weak if the bonding distance between the two is short, the possibility that the bonding may be destroyed even by a small impact becomes high. That is, as the bonding distance between the hanging portion 26c and the first cylinder portion 20b is made longer, the bonding becomes stronger against an impact.

On the other hand, when the flange 26e becomes thick, the capillary seal portion TS becomes short, thereby causing the capacity of the lubricant 28 that can be held in the capillary seal portion TS to be small. Accordingly, there is the possibility that, when the lubricant 28 is dispersed due to an impact, the lubricant 28 may be immediately lacking. The functions of a fluid dynamic bearing are deteriorated due to such a lack in the lubricant and therefore a malfunction, such as burning, is likely to occur. Accordingly, in the disk drive device 100 according to the present embodiment, the capillary seal portion TS is made long in the up-down direction by thinning the flange 26e. As a result, an amount of the lubricant 28 that can be held therein becomes large, and the disk drive device 100 is structured such that the lubricant 28 is hardly lacking even if dispersed due to an impact. That is, the axial distance of the thrust member 26 is made to be long with respect to the hanging portion 26c and to be short with respect to the flange 26e.

There is a method in which the outer circumferential surface of the hanging portion 26c is fixed to the inner circumferential surface of the first cylinder portion 20b by press-fitting; however, there is the fear that, when the hanging portion 26c receives stress due to the press-fitting, a deformation may occur in the inner circumferential surface of the hanging portion 26c, thereby possibly impairing the functions of the capillary seal portion TS. Accordingly, in the present embodiment, the outer circumferential surface of the hanging portion 26c is made small in diameter than the inner circumferential surface of the first cylinder portion 20b and both are fixed together by adhesion. As a result, a deformation in the hanging portion 26c is prevented and the functions of the capillary seal portion TS can be sufficiently exhibited.

The magnet 24 is fixed to the inner circumference of the second cylinder portion 20c and provided so as to face the outer circumference of the stator core 12 via narrow gap. The magnet 24 is formed of an Nd—Fe—B (Neodymium-Ferrum-Boron) material. Electro-deposition coating or spray coating is performed on the surface of the magnet 24, and the inner circumference thereof is magnetized with twelve poles.

Subsequently, a dynamic pressure bearing in the structure of the disk drive device 100 will be described. A radial dynamic pressure bearing includes a radial dynamic pressure generating portion comprising the outer circumferential surface 22c of the shaft 22, the cylinder portion inner circumferential surface 16a of the sleeve 16, and the lubricant 28, such as oil, etc., which is injected into the gap between the two. The radial dynamic pressure generating portion is composed of a plurality of individual dynamic pressure generating portions. In the present embodiment, as individual radial dynamic pressure generating portions, the first radial dynamic pressure generating portion RB1 is arranged away from the hub 20 and the second radial dynamic pressure generating portion RB2 is arranged near to the hub 20 in the state where the two are spaced apart from each other in the axial direction. The first radial dynamic pressure generating portion RB1 and the second radial dynamic pressure generating portion RB2 are provided in the gap between the cylinder portion inner circumferential surface 16a and the outer circumferential surface 22c so as to support the rotating body R by generating radial dynamic pressure. The first radial dynamic pressure generating portion RB1 and the second dynamic pressure generating portion RB2 respectively have a first radial dynamic pressure groove and a second radial dynamic pressure groove for generating dynamic pressure on at least one of the outer circumferential surface 22c and the cylinder portion inner circumferential surface 16a, the two surfaces 22c and 16a facing each other.

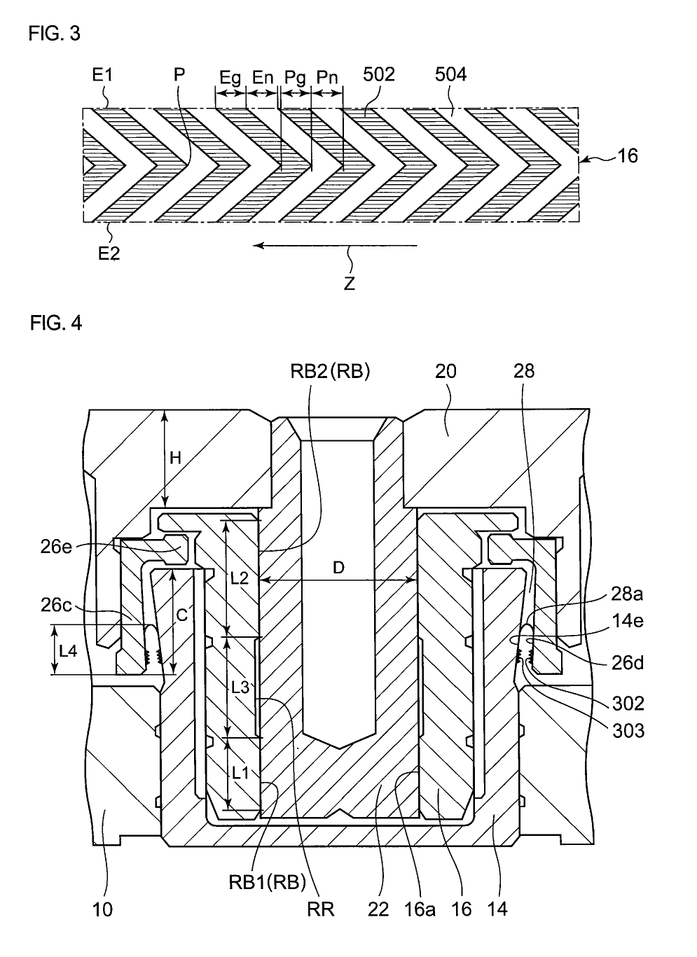

Subsequently, radial dynamic pressure grooves composing the first radial dynamic pressure generating portion RB1 and the second radial dynamic pressure generating portion RB2 will be described. It is noted that, because a radial dynamic pressure groove composing the first radial dynamic pressure generating portion RB1 and that composing the second radial dynamic pressure generating portion RB2 can be basically the same as each other, the two will be collectively described as a radial dynamic pressure groove in the radial dynamic pressure generating portion RB. FIG. 3 is an illustrative view illustrating an example of a state in which the radial groove formed on the cylinder portion inner circumferential surface 16a of the sleeve 16, the cylinder portion inner circumferential surface 16a forming the radial space portion including the radial dynamic pressure generating portion RB, is expanded in the circumferential direction. In FIG. 3, the hatching areas represent groove portions 502 functioning as radial grooves and other areas represent non-groove portions 504. As illustrated in FIG. 3, the radial dynamic pressure generating portion RB is composed of a plurality of striped groove portions in which the groove portion 502 and the non-groove portion 504 are repeatedly arranged along the rotational direction (the circumferential direction of the sleeve 16) Z. In the case of the structure of the present embodiment, each striped groove portion is formed by the end portions E1 and E2 on both sides and the intermediate portion P sandwiched by the end portions E1 and E2 on both sides, and the end portions E1 and E2 on both sides are arranged at positions preceding the intermediate portion P toward the Z direction, which is opposite to the rotational direction of the shaft 22. That is, the end portions E1 and E2 on both sides and the intermediate portion P are arranged such that the lubricant 28 is collected into the intermediate portion P by the relative rotation between the shaft 22 and the sleeve 16. In the case of the radial dynamic pressure generating portion RB, there are two types of the structures, in one of which the sleeve 16 is fixed and the shaft 22 rotates as illustrated in FIG. 2, and in the other of which the shaft 22 is fixed and the sleeve 16 rotates, opposite to the first one. In addition, there are three types with respect to where the radial dynamic pressure is formed, in the first one of which the radial dynamic pressure groove is formed on the sleeve 16 side as illustrated in FIG. 3, in the second one of which that is formed on the shaft 22 side, and in the last one of which that are formed on both sides of the sleeve 16 and the shaft 22. In every case, the end portions E1 and E2 on both sides and the intermediate portion P composing the striped groove portion are arranged such that the lubricant 28 is collected into the intermediate portion P by the relative rotation between the shaft 22 and the sleeve 16. Accordingly, the arrangement relationship between the end portions E1 and E2 and the intermediate portion P composing the striped groove portion is determined in accordance with the rotational pattern of the sleeve 16 and the shaft 22 and the formation pattern of the striped groove portion. FIG. 3 illustrates the case where the radial groove is formed to be herringborn-shaped as an example of the shape of the radial groove. In this case, it can be said that the intermediate portion P represents the periphery of the top of the herringbone-shape.

For example, when the diameter of the radial dynamic pressure generating portion RB is 4 mm, the number of the groove portions 502 per circumference can be twelve. Further, the circumferential width Pg of the intermediate portion P and that Eg of each of the end portions E1 and E2 in the groove portion 502, can be approximately 0.52 mm, respectively. Alternatively, when the diameter of the radial dynamic pressure generating portion RB is 3 mm, the number of the groove portions 502 per circumference can be eight, and the circumferential widths Pg and Eg of the intermediate portion P and each of the end portions E1 and E2 in the groove portion, can be approximately 0.59 mm, respectively. In addition, the radial depth of the groove portion 502 can be, for example, 5 to 6 μm. The radial gap between the cylinder portion inner circumferential surface 16a and the outer circumferential surface 22c can be 3 to 4 μm.

When the rotating body R is rotating, the radial dynamic pressure groove generates radial dynamic pressure such that the shaft 22 is supported by the radial dynamic pressure via a predetermined radial gap relative to the sleeve 16. The axial formation width of the first radial dynamic pressure groove in the first radial dynamic pressure generating portion RB1 is formed to be narrower than that of the second radial dynamic pressure grove in the second radial dynamic pressure generating portion RB2. Thereby, a pair of radial dynamic pressure corresponding to a pair of side pressure with different strength in the axial direction of the shaft 22 are generated in the first radial dynamic pressure generating portion RB1 and the second radial dynamic pressure generating portion RB2. The shaft 22 near to a weight member, such as the hub 20, etc., is stably supported by generating large dynamic pressure in the radial dynamic pressure generating portion RB2, as stated above. On the other hand, the shaft 22 is supported by generating radial dynamic pressure in the first radial dynamic pressure generating portion RB1, which is smaller than that in the second radial dynamic pressure generating portion RB2. As a result, smooth rotation of the shaft 22 is realized, thereby allowing for high shaft stiffness to be obtained. It is noted that the generation of radial dynamic pressure means, in other words, generation of rotational resistance, thereby causing a shaft loss occurring when the shaft 22 is being driven. However, the shaft loss can be reduced by making the radial dynamic pressure generated in the first radial dynamic pressure generating portion RB1 small. Accordingly, optimal balance between the high shaft stiffness and the low shaft loss can be acquired by adjusting a pair of radial dynamic pressure generated in the first radial dynamic pressure generating portion RB1 and the second radial dynamic pressure generating portion RB2.

On the other hand, a thrust dynamic pressure bearing includes the first thrust dynamic pressure generating portion SB1 and the second thrust dynamic pressure generating portion SB2, as illustrated in FIG. 2. The first thrust dynamic pressure generating portion SB1 is formed by the thrust lower surface 26b of the flange 26e, the housing flat portion 14d, and the lubricant 28 injected into the axial gap between the two. The second thrust dynamic pressure generating portion SB2 is formed by the thrust upper surface 26a of the flange 26e, the lower surface of the circumferentially-protruding portion 16b, and the lubricant 28 injected into the axial gap direction between the two.

In each of the thrust dynamic pressure generating portion SB1 and the second thrust dynamic pressure generating portion SB2, a thrust dynamic pressure groove (not illustrated) for generating dynamic pressure is formed on at least one of the surfaces in the axial gap. The thrust dynamic pressure groove may be formed, for example, to be spiral-shaped, or to be herringborn-shaped in the same way as the radial dynamic pressure groove. The thrust dynamic pressure generating portion SB generates, as a whole, the dynamic pressure in the pump-in direction, in which the lubricant 28 is transferred from the capillary seal portion TS toward the inside of the bearing unit, with the rotation of the rotating body R, so that an axial force, i.e., a floating force will act on the rotating body by the pressure. The lubricant 28 injected into the gaps in the first radial dynamic pressure generating portion RB1, the second radial dynamic pressure generating portion RB2, the first thrust dynamic pressure generating portion SB1, and the second thrust dynamic pressure generating portion SB2, is commonly used with each other and a leak of the lubricant 28 is prevented by being sealed with the capillary seal portion TS.

The capillary seal portion TS is composed of the outer circumferential surface 14e of the housing 14 and the inner circumferential surface 26d of the thrust member 26. The outer circumferential surface 14e is tapered so as to be reduced in diameter going from the upper surface toward the lower surface. On the other hand, the inner circumferential surface 26d facing the outer circumferential surface 14e is also tapered so as to be reduced in diameter going from the upper surface toward the lower surface, although its tilt angle is smaller than that of the outer circumferential surface 14e. With such a structure, the outer circumferential surface 14e and the inner circumferential surface 26d form the capillary seal portion TS in which the gap between the two expands going from the upper surface toward the lower surface. Herein, an injection amount of the lubricant 28 is set such that the boundary surface (gas-liquid interface) between the lubricant 28 and ambient air is located in the middle of the capillary seal portion TS, and therefore the lubricant 28 is sealed by the capillary seal portion TS with capillarity. As a result, a leak of the lubricant 28 is prevented. That is, the lubricant 28 is to be injected into a lubricant holding portion including: the spaces forming the first radial dynamic pressure generating portion RB1, the second radial dynamic pressure generating portion RB2, the first thrust dynamic pressure generating portion SB1, and the second thrust dynamic pressure generating portion SB2; the space between the housing 14 and the thrust member 26; and the space between the circumferentially-protruding portion 16b and the hub 20, etc.

As stated above, the capillary seal portion TS is designed such that the inner circumferential surface 26d, which is the outside tilted surface, is reduced in diameter going from the upper surface toward the lower surface. Accordingly, with the rotation of the rotating body R, a centrifugal force acts on the lubricant 28 in the direction where the lubricant 28 is forced to move toward the inside of the space into which the lubricant 28 is injected, and therefore a leak of the lubricant 28 can be more surely prevented. Further, the communication channel I can be secured by the groove 14a formed along the axial direction on the inner circumferential surface of the housing 14. Because both sides of the first radial dynamic pressure generating portion RB1 and the second radial dynamic pressure generating portion RB2 are communicated by the communication channel I, the pressure balance in the radial dynamic pressure bearing can be immediately restored even if the pressure balance breaks down, thereby allowing for the total pressure balance to be successfully maintaining. Further, if the dynamic pressure balance in each of the first radial dynamic pressure generating portion RB1, the second radial dynamic pressure generating portion RB2, and the thrust dynamic pressure generating portion SB, breaks down due to a disturbance, such as application of an external force on the shaft 22 or the rotating body R, the pressure is instantly averaged and the pressure balance can be maintained. As a result, an floating amount of the rotating body R is stabilized relative to the fixed body S, allowing for a disk drive device 100 with high reliability to be obtained.

The first radial dynamic pressure generating portion RB1 and the second radial dynamic pressure generating portion RB2, functioning as individual radial dynamic pressure generating portions, will be described in detail with reference to FIG. 4. FIG. 4 is a partial cross-sectional view mainly illustrating the relationship between the diameter of the radial dynamic pressure generating portion RB and the axial length thereof.

As stated above, a disk drive device 100 to be mounted in a mobile device is demanded such that a drive current should be reduced. The present inventors have found from experiments that a reduction in a drive current can be realized by making the diameter D of the radial dynamic pressure generating portion RB small in the structures illustrated in FIGS. 2 and 4. In the present embodiment, an example in which a radial dynamic pressure groove composing the radial dynamic pressure generating portion RB is formed on the cylinder portion inner circumferential surface 16a of the sleeve 16 will be described.

The circumferential formation length of the radial dynamic pressure groove becomes short by making the diameter D of the radial dynamic pressure generating portion RB small. That is, the number of the radial dynamic pressure grooves or the capacity of the grooves of the whole radial dynamic pressure groove, the radial dynamic pressure groove(s) being formed on the cylinder portion inner circumferential surface 16a, is reduced, and thereby the resistance to the lubricant 28 is reduced. As a result, the drive current for rotating the rotating body R can be reduced. Alternatively, if the diameter D of the radial dynamic pressure generating portion RB is made small in the state where the gap size between the outer circumferential surface 22c of the shaft 22 and the cylinder portion inner circumferential surface 16a of the sleeve 16 is maintained, the diameter of the shaft 22 to be housed in the sleeve 16 also becomes small. That is, the weight as the whole rotating body R can be reduced, thereby contributing to a reduction in a drive current. Similarly, the present inventors have found that a drive current can also be reduced by making the radial depth G of the radial dynamic pressure groove shallow. Also, in this case, the resistance to the lubricant 28 can be reduced by a reduction in the capacity of the grooves of the whole radial dynamic pressure groove. As a result, the drive current for driving the rotating body R can be reduced. Further, the inventors have also found that the sleeve 16 and the radial dynamic pressure groove can be stably processed with the dimension accuracy of the sleeve 16 and the shape accuracy of the radial dynamic pressure groove being maintained, by setting, for example, the diameter D of the radial dynamic pressure generating portion RB to 2.5 mm, the depth G thereof to 3 to 4 μm, and the gap between the cylinder portion inner circumferential surface 16a and the outer circumferential surface 22c to 2 to 3 μm. In this case, the inventors have confirmed that the sleeve 16 can be processed with high accuracy by cutting.

Herein, if the diameter D of the radial dynamic pressure generating portion RB composing the first radial dynamic pressure generating portion RB1 and the second radial dynamic pressure generating portion RB2 or the depth G of the radial dynamic pressure groove is made small, generated radial dynamic pressure becomes small in accordance with the reduction amount thereof. That is, the radial bearing stiffness is on the trend of being decreased. As stated above, when an impact is applied to a disk drive device, a displacement of the recording disk 120, corresponding to the stress occurring due to the acceleration of the impact, becomes large if the radial bearing stiffness is low. And, when an displacement of the recording disk 120 becomes large, the relative distance between the magnetic head and the recording disk 120 becomes unstable, thereby increasing errors in reading/writing data.

Because of this, it is needed that radial dynamic pressure should be increased while maintaining the state where the diameter D of the radial dynamic pressure generating portion RB is reduced. The present inventors have found that radial dynamic pressure is approximately defined with the axial length of the radial dynamic pressure generating portion RB and the diameter D thereof being parameters. That is, the inventors have acquired the conclusion that it is successful to determine the axial length of the radial dynamic pressure generating portion RB and the diameter D thereof such that the radial dynamic pressure to be generated is greater than or equal to the minimum reference value determined beforehand in the design step.

That is, when the relationship between the sum (L1+L2) of the axial size L1 of the first radial dynamic pressure generating portion RB1 and that L2 of the second radial dynamic pressure generating portion RB2, and the diameter D of the radial dynamic pressure generating portion RB, is made to satisfy (L1+L2)>D, the needed radial dynamic pressure can be secured while reducing a drive current. Herein, when (L1+L2) is increased, the radial dynamic pressure can be increased in accordance with the increase thereof and the impact resistance performance of the disk drive device 100 when in use can be improved, thereby allowing for a stable operation to be realized. In addition, if the diameter D of the shaft 22 can be determined, in the design step, in accordance with the specification of the disk drive device 100, the diameter D of the radial dynamic pressure generating portion RB can be determined, and further the length of the radial dynamic pressure generating portion RB can be determined, thereby allowing for the radial dynamic pressure generating portion RB to be easily designed.

In addition, because the axial length of the radial dynamic pressure generating portion is increased, the capacity of the groove is increased accordingly, thereby increasing the resistance to the lubricant 28. However, the shaft 22 can be reduced in weight with the shaft 22 becoming narrow in accordance with the reduction in the diameter D of the radial dynamic pressure generating portion RB. Part of the increase in a drive current due to the increase in the axial length of the radial dynamic pressure generating portion can be offset by the reduction in a drive current due to the reduction in weight, a reduction in a drive current can be realized as the whole disk drive device 100.

The present inventors have confirmed from experiments that, when the diameter D of the radial dynamic pressure generating portion RB is 2.4 mm and L1+L2=2.5 mm as a specific example, good balance between a generation amount of the radial dynamic pressure and a reduction in a drive current can be obtained. Further, the inventors have confirmed from experiments that the diameter D of the radial dynamic pressure generating portion RB can be made to be smaller than or equal to 2.4 mm. The inventors have also confirmed that, in this case, there is an advantage because a drive current is further reduced and the period when a battery-powered disk drive device 100 can be used becomes long. Also, in this case, sufficient bearing stiffness can be secured by adjusting the axial size of the radial dynamic pressure generating portion RB in accordance with a decrease in the stiffness.

If the axial length of the radial dynamic pressure generating portion RB is made simply long, the axial size of the disk drive device 100 becomes long, contradicting the thinning of a disk drive device 100, which has been conventionally demanded. The present inventors have learned from experiments that a larger portion of the acceleration due to an impact applied to the recording disk 120 acts on the second radial dynamic pressure generating portion RB2 located near to the hub 20 than on the first radial dynamic pressure generating portion RB1 located away from the hub 20. And, the inventors have found that it is successful to generate larger dynamic pressure in the second radial dynamic pressure generating portion RB2 by making the axial size L2 of the second radial dynamic pressure generating portion RB2 located near to the hub 20 longer than that L1 of the first radial dynamic pressure generating portion RB1 located away from the hub 20. By forming such generation balance of the radial dynamic pressure, the impact resistance performance of the disk drive device 100 when in use can be improved, and balance distribution of the radial dynamic pressure, corresponding to the weight of the rotating body R, can be concurrently performed as stated above, as stated above, thereby allowing for stable rotation of the rotating body R to be realized. The generation balance of the radial dynamic pressure can be realized by adjusting the axial sizes L1 and L2 of the first radial dynamic pressure generating portion RB1 and the second radial dynamic pressure generating portion RB2 or adjusting the depth G of the groove. By performing such adjustment, needed radial dynamic pressure can be secured while reducing a drive current, and the impact resistance performance of a disk drive device 100 when in use can be improved, thereby allowing for an stable operation to be realized.

In addition, as one of the demands with respect to a disk drive device 100, there is the demand that the axial size of a disk drive device 100 should be thinned while improving the impact resistance performance thereof. As illustrated in FIG. 4, a liquid reservoir RR for the lubricant 28, the liquid reservoir RR becoming a non-radial dynamic pressure generating portion, is formed such that the axial length thereof is L3, between the first radial dynamic pressure generating portion RB1 and the second radial dynamic pressure generating portion RB2. In order to stably and efficiently support the shaft 22 with a predetermined length, it is desirable to support the shaft 22 at a plurality of positions spaced apart from each other in the axial direction of the shaft 22. To realize this, the first radial dynamic pressure generating portion RB1 and the second radial dynamic pressure generating portion RB2 are arranged so as to be spaced from each other and the liquid reservoir RR is formed between the two. The liquid reservoir RR also functions as a buffer space of the lubricant 28, thereby contributing to avoidance of lack in the lubricant 28. However, the liquid reservoir RR itself does not contribute to the generation of the radial dynamic pressure. Accordingly, the present inventors have made the axial size L3 of the liquid reservoir RR smaller than the sum (L1+L2) of the axial sizes of the radial dynamic pressure generating portion RB, with avoidance of lack in the lubricant 28 being dealt with, for example, the shape of the capillary seal portion TS, etc. As a result, it becomes possible to expand an area where the radial dynamic pressure generating portion RB can be formed, thereby it becomes possible to reduce a drive current and improve the impact resistance performance of the disk drive device 100 while avoiding the expansion of the axial size due to the formation of the radial dynamic pressure generating portion RB, that is, the expansion of the axial size of the disk drive device 100. Further, the reduction in the axial size L3 of the liquid reservoir RR contributes to the thinning of the axial size of the disk drive device 100. Alternatively, the axial size L3 of the liquid reservoir RR may be made smaller than the diameter of the liquid reservoir RR in order to further thin the axial size of the disk drive device 100. This case also leads to the expansion of the area where the radial dynamic pressure generating portion RB can be formed, thereby contributing to suppression of a decrease in the bearing stiffness.

The axial size of the hub 20 is sometimes made large in order to realize the stable rotation of the rotating body R. When meeting the demand of thinning the disk drive device 100 in view of this, the axial size of the capillary seal portion TS becomes small. In this case, when an impact is applied to the disk drive device 100, the lubricant 28 in the capillary seal portion TS is sometimes dispersed, resulting in an decrease in the amount of the lubricant 28. When the amount of the lubricant 28 is decreased, the lifetime of the disk drive device 100 is sometimes shortened. Then, in the present embodiment, the axial size C of an area where the outer circumferential surface 14e of the housing 14 and the inner circumferential surface 26d of the hanging portion 26c face each other in the radial direction, is made larger than the axial size H of the hub 20 located on the line extended in the axial direction from the outer circumferential surface 14e of the housing 14, in FIG. 4. As illustrated in FIG. 4, the portion corresponding to the axial size C composes the capillary seal portion TS, and the distance L4 between the gas-liquid interface 28a of the lubricant 28 stored in the capillary seal portion TS and the end surface of the hanging portion 26c can be made long by making the axial size C long. With this, the margin space for movement of the lubricant 28, the movement occurring when the disk drive device 100 receives an impact, can be sufficiently secured, thereby allowing for the performance of preventing dispersion of the lubricant 28 to be improved. As a result, a decrease in the lubricant 28 can be suppressed and a decrease in the lifetime of the disk drive device 100 can be suppressed. As stated above, by improving the performance of preventing a leak of the lubricant 28 in the disk drive device 100, the load occurring when driving the disk drive device 100 can be reduced and the reliability for maintaining the bearing stiffness can be improved while avoiding excessive consumption of a drive current.

In addition, in the present embodiment, application portions 302 and 303 where an oil-repellent agent is applied may be provided, in the circumferential direction, on both the inner circumferential surface 26d of the thrust member 26 located near to the open end of the capillary seal portion TS and the outer circumferential surface 14e of the housing 14, as illustrated in FIG. 4, in order to suppress a lack in the lubricant 28. The oil-repellent agent is made by solving, for example, Teflon resin in a solvent, and Teflon resin films are formed by evaporating the solvent in the application portions 302 and 303. It can be designed that the lubricant 28, once dispersed from the gas-liquid interface 28a of the lubricant 28, will return to the reservoir area of the lubricant 28 after being repelled by the application portions 302 and 33 due to the Teflon resin films. As a result, a decrease in the lubricant 28 can be easily suppressed. The positions where the application portions 302 and 303 are provided may be appropriately set so long as they are located between the gas-liquid interface 28a and the open end. By improving the performance of preventing a leak of the lubricant 28 in the disk drive device 100 as stated above, the load occurring when driving the disk drive device 100 can be reduced and the reliability for maintaining the bearing stiffness can be improved while avoiding excessive consumption of a drive current.

In the present embodiment, the diameter of the sleeve 16 between the first radial dynamic pressure generating portion RB1 and the second radial dynamic pressure generating portion RB2 is made large as illustrated in FIG. 4, in order to form the aforementioned liquid reservoir RR. When receiving an impact by which the lubricant 28 is forced to be displaced upwards in the axial direction, the lubricant 28 held in the liquid reservoir RR makes a force in the direction where the lubricant 28 held in the capillary seal portion TS is extruded. Due to this, if the axial size L3 is large, the amount of the lubricant 28 held in the liquid reservoir RR becomes large and thereby the lubricant 28 held in the capillary seal portion TS is sometimes pushed out and is likely to be dispersed. Accordingly, as illustrated in the present embodiment, the axial size C of an area where the outer circumferential surface 14e of the housing 14 and the inner circumferential surface 26d of the hanging portion 26c of the thrust member 26 face each other in the radial direction, may be larger than the axial size L3 of the liquid reservoir RR, as illustrated in FIG. 4. By satisfying L3<C, a dispersion amount of the lubricant 28 can be suppressed by reducing a phenomenon in which the lubricant 28 is pushed out from the capillary seal portion TS when an external force is applied to the lubricant 28. By improving the performance of preventing a leak of the lubricant 28 in the disk drive device 100 in this way, the load occurring when driving the disk drive device 100 can be reduced and the reliability for maintaining the bearing stiffness can be improved while avoiding excessive consumption of a drive current.

Alternatively, the surface roughness of at least one of both areas on the outer circumferential surface 14e of the housing 14 and the inner circumferential surface 26d of the hanging portion 26c, both the areas facing each other, may be larger than that of the outer circumferential surface 22c of the shaft 22. The present inventors have confirmed from experiments that, if the surface of the area in this case is formed such that Ry is greater than or equal to 1.6, the resistance force to the movement of the lubricant 28, occurring due to a surface tension, is increased. As a result, a dispersion amount of the lubricant 28 can be suppressed. By improving the performance of preventing a leak of the lubricant 28 in the disk drive device 100 in this way, the load occurring when driving the disk drive device 100 can be reduced and the reliability for maintaining the bearing stiffness can be improved while avoiding excessive consumption of a drive current.

Alternatively, at least one of both areas of the outer circumferential surface 14e of the housing 14 and the inner circumferential surface 26d of the hanging portion 26c, both the areas facing each other, may be subjected to a hydrophilic treatment. A hydrophilic treatment is one for making the contact angle with the lubricant 28 small by modifying the surface. By subjecting these areas to a hydrophilic treatment, the resistance force to the movement of the lubricant 28, occurring due to a surface tension, is increased. As a result, a dispersion amount of the lubricant 28 can be suppressed. As a hydrophilic treatment, various techniques can be employed. For example, hydrophilic treatments by titanium coating, glass coating, silica coating, organic-inorganic composite ceramic coating, and UV irradiation, are preferred for the use in the present embodiment in terms of easy work and a successful hydrophilic effect. Among hydrophilic treatments, a treatment in which the contact angle is made to be smaller than or equal to 10° is sometimes particularly called a superhydrophilic treatment. By subjecting at least one of both areas of the outer circumferential surface 14e of the housing 14 and the inner circumferential surface 26d of the hanging portion 26c, both the areas facing each other, to a superhydrophilic treatment, a dispersion amount of the lubricant 28 can be further suppressed. By improving the performance of preventing a leak of the lubricant 28 in the disk drive device 100 in this way, the load occurring when driving the disk drive device 100 can be reduced and the reliability for maintaining the bearing stiffness can be improved while avoiding excessive consumption of a drive current.

As another example in which a dispersion amount of the lubricant 28 is suppressed, a structure may be provided in the space between the outer circumferential surface 14e of the housing 14 and the inner circumferential surface 26d of the hanging portion 26c, in which the lubricant 28 is forced to move inwards (to the direction of the non-open end) with the rotation of the hub 20. For example, a lubricant moving portion in which the lubricant 28 is forced to move inwards from the open end of the capillary seal portion TS with the rotation of the hub 20, may be formed on at least one of the outer circumferential surface 14e of the housing 14 and the inner circumferential surface 26d of the hanging portion 26c. The lubricant moving portion can be composed of a spiral groove tilted so as to generate pressure by which the lubricant 28 is guided toward the inside of the capillary seal portion TS when the hanging portion 26c, together with the hub 20, is rotating in the rotational direction of the recording disk 120. By forming such a lubricant moving portion, a stream of the lubricant 28 by which the lubricant 28 is suppressed from moving to the direction where it will be dispersed, can be formed inside the lubricant 28 even when an impact is applied to the disk drive device 100 while the hub 20 is rotating. As a result, the dispersion of the lubricant 28 can be successfully and efficiently suppressed. By improving the performance of preventing a leak of the lubricant 28 in the disk drive device 100 in this way, the load occurring when driving the disk drive device 100 can be reduced and the reliability for maintaining the bearing stiffness can be improved while avoiding excessive consumption of a drive current.

In addition, as another example in which a dispersion amount of the lubricant 28 is suppressed, it may be designed that the gas-liquid interface 28a of the lubricant 28 at rest is located approximately at the axial center of an area where the outer circumferential surface 14e of the housing 14 and the inner circumferential surface 26d of the hanging portion 26c face each other in the radial direction. By setting the gas-liquid interface 28a of the capillary seal portion TS in this way, the distance to the open end of a capillary seal formation area formed by the lower end of the inner circumferential surface 26d and the outer circumferential surface 14e, can be secured. That is, the outward dispersion of the lubricant 28 can be reduced by a buffer space to the open end, even if the level of the gas-liquid interface 28a varies when an impact has been applied to the disk drive device 100. By improving the performance of preventing a leak of the lubricant 28 in the disk drive device 100 in this way, the load occurring when driving the disk drive device 100 can be reduced and the reliability for maintaining the bearing stiffness can be improved while avoiding excessive consumption of a drive current.

In the present embodiment, the present inventors have confirmed the following fact: when the diameter D of the radial dynamic pressure generating portion RB is 2.5 mm, it is preferable that the difference between the maximum and the minimum of the axial liquid level in the circumferential direction of the gas-liquid interface 28a of the lubricant 28 at rest, is made to be smaller than or equal to 0.2 mm. It is noted that, in this case, the liquid level at the side where the distance to the open end of the capillary seal formation area become smaller is assumed to be the maximum liquid level, and that at the side where the distance thereto becomes larger is assumed to be the minimum liquid level. By setting such an acceptable range of the difference between the liquid levels, the securement of the needed distance to the open end of the capillary seal formation area can be ensured, even if the liquid level of the lubricant 28 varies after an impact has been applied to the disk drive device 100. By improving the performance of preventing a leak of the lubricant 28 in the disk drive device 100 in this way, the load occurring when driving the disk drive device 100 can be reduced and the reliability for maintaining the bearing stiffness can be improved while avoiding excessive consumption of a drive current.

A change in the circumferential liquid level of the gas-liquid interface 28a of the lubricant 28 in the capillary seal portion TS is caused due to a circumferential change in the gap between the outer circumferential surface 14e of the housing 14 and the inner circumferential surface 26d of the hanging portion 26c. That is, at the portion where the gap is relatively narrow, the gas-liquid interface 28a of the lubricant 28 is located downwards in FIG. 4, and at the portion where the gap is relative wide, that is located upwards. The circumferential change in the gap becomes small when the coaxial degree of the hanging portion 26c relative to the rotational center is high.

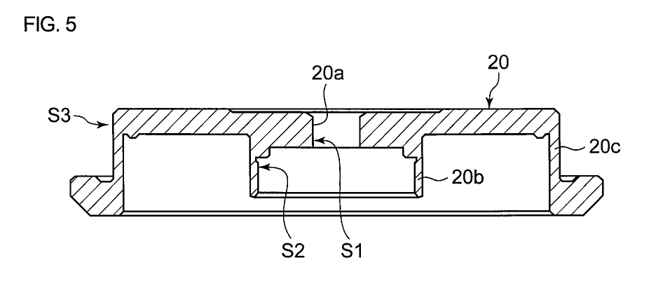

FIG. 5 is a cross-sectional view illustrating a processed portion of the hub 20 to be used in the present embodiment. As stated above, the hanging portion 26c of the thrust member 26 is fixed to the inner circumferential surface of the first cylinder portion 20b of the hub 20 with adhesive. Accordingly, when the coaxial degree of the inner circumferential surface 26d relative to the outer shape of the hanging portion 26c of the thrust member 26 is obtained, it is needed that the inner circumferential surface of the first cylinder portion 20b of the hub 20 is formed concentrically with the center hole 20a in order to obtain the coaxial degree relative to the rotational center of the hanging portion 26c. Then, in the present embodiment, the surface represented by the arrow Si and the surface represented by the arrow S2 in FIG. 5 are continuously cut. Herein, the continuous cutting means that, for example, the center hole 20a and the inner circumferential surface of the first cylinder portion 20b of the hub 20 are cut while the hub 20 is being chucked with a lathe. With such cutting, high coaxial degree of the first cylinder portion 20b relative to the center hole 20a can be obtained, the center hole 20a being a processing reference in the hub 20. As a result, successful coaxial degree can be obtained when fixing the hanging portion 26c to the hub 20. And accordingly, the difference between the maximum and minimum of the axial liquid level in the circumferential direction of the gas-liquid interface 28a of the lubricant 28 in the capillary seal portion TS, becomes small. Thus, by improving the performance of preventing a leak of the lubricant 28 in the disk drive device 100, the load occurring when driving the disk drive device 100 can be reduced and the reliability for maintaining the bearing stiffness can be improved while avoiding excessive consumption of a drive current.

Further, in another example, the outer circumferential surface of the second cylinder portion 20c of the hub 20 and the inner circumferential surface of the first cylinder portion 20b may be continuously processed. As stated above, the hub 20 comprises the second cylinder portion 20c to be engaged with the center hole of the recording disk 120. That is, the surface represented by the arrow S2 and that represented by the arrow S3 in FIG. 5 are continuously cut. Herein, the continuous cutting means that, for example, the outer circumferential surface of the second cylinder portion 20c and the inner circumferential surface of the first cylinder portion 20b are continuously cut while the hub 20 is being chucked with a lathe. With such cutting, high coaxial degree of the first cylinder portion 20b relative to the second cylinder portion 20c can be obtained, the second cylinder portion 20c being another processing reference in the hub 20. As a result, successful coaxial degree can be obtained when fixing the hanging portion 26c to the hub 20. And accordingly, the difference between the maximum and the minimum of the axial liquid level in the circumferential direction of the gas-liquid interface 28a of the lubricant 28 in the capillary seal portion TS, becomes small. Thus, by improving the performance of preventing a leak of the lubricant 28 in the disk drive device 100, the load occurring when driving the disk drive device 100 can be reduced and the reliability for maintaining the bearing stiffness can be improved while avoiding excessive consumption of a drive current.

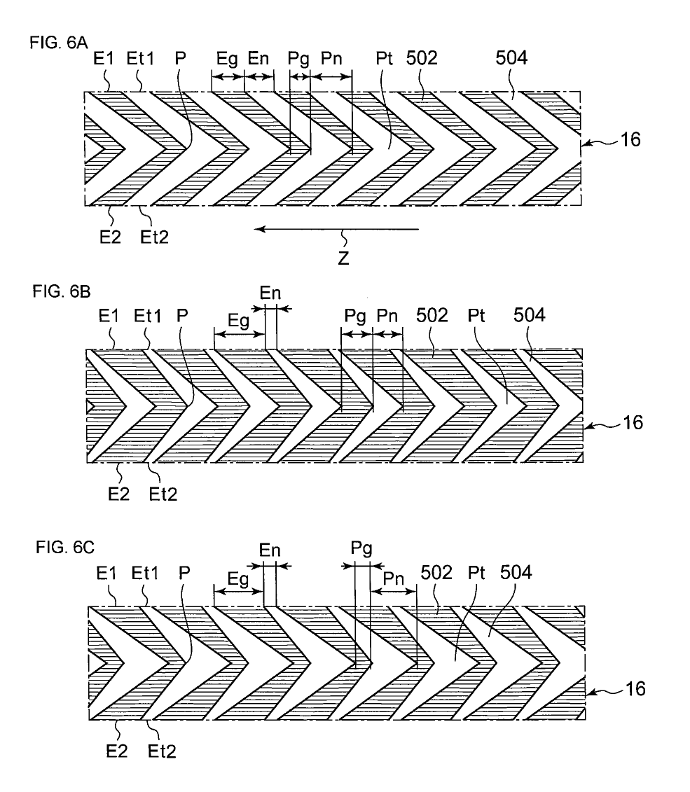

In the present embodiment, the radial dynamic pressure generating portion RB is composed of a plurality of the striped groove portions as illustrated in FIG. 3, in which the groove portion 502 and the non-groove portion 504 are repeatedly arranged along the Z direction (the circumferential direction of the sleeve 16), the Z direction being opposite to the rotational direction of the shaft 22. The radial dynamic pressure to be generated in the radial dynamic pressure generating portion RB can be adjusted by changing the shape of the striped groove portion. FIGS. 6A to 6C are illustrative views illustrating variations of the striped groove portion. Also, in FIGS. 6A to 6C, the radial grooves formed on the cylinder portion inner circumferential surface 16a of the sleeve 16, the cylinder portion inner circumferential surface 16a composing the radial dynamic pressure generating portion RB, are illustrated after being expanded in the circumferential direction. Also, in FIGS. 6A to 6C, the hatching areas represent the groove portions 502 and other areas represent the non-groove portions 504 in the same way as FIG. 3. As illustrated in FIGS. 6A to 6C, the radial dynamic pressure generating portion RB is composed of a plurality of the striped groove portions in which the groove portion 502 and the non-grove portion 504 are repeatedly arranged along the Z direction. Each striped groove portion is formed by the end portions E1 and E2 on both sides and the intermediate portion P sandwiched by the end portions E1 and E2 on both sides, and the end portions E1 and E2 on both sides are arranged at positions preceding the intermediate portion P toward the Z direction. Also, in FIGS. 6A to 6C, the case where the radial groove is formed to be herringborn-shaped as an example of the shape is illustrated. Further, each of FIGS. 6A to 6C illustrates a type in which the sleeve 16 is fixed, the shaft 22 rotates, and the striped groove portion is formed on the side of the sleeve 16, in the same way as FIG. 3.

In the case of FIG. 6A, the circumferential width Eg of each of the end portions E1 and E2 in the groove portion 502 is formed to be larger than the circumferential width Pg of the intermediate portion P in the groove 502. The lubricant 28 lying in the radial space portion is scraped up in the end portions E1 and E2 in the groove portion 502 and guided toward the intermediate portion P by the relative rotation between the cylinder portion inner circumferential surface 16a of the sleeve 16 and the outer circumferential surface 22c of the shaft 22. The guided lubricant 28 generates the radial dynamic pressure acting on the shaft 22 by running on a protruding center convex portion Pt in the non-groove portion 504, the center convex portion Pt corresponding to the intermediate portion P. In this case, by making the circumferential width Pg of the intermediate portion P narrower than that Eg of each of the end portions E1 and E2, a phenomenon can be created in which the lubricant 28 scraped up in the end portions E1 and E2 is strongly forced into the intermediate portion P. And accordingly, the radial dynamic pressure generated near the center convex portion Pt can be made large. As a result, the radial stiffness can be increased with the radial dynamic pressure efficiently acting on the shaft 22. Further, as illustrated in FIG. 2, even when a drive current is reduced by making the diameter D of the radial dynamic pressure generating portion RB, a decrease in the radial stiffness can be covered by increasing a generation amount of the radial dynamic pressure with the shape of the groove portion 502. That is, the radial stiffness can be increased.

Alternatively, the circumferential width Pg of the intermediate portion P in the groove portion 502 may be smaller than that Pn of the center convex portion Pt in the non-groove portion 504, as illustrated in FIG. 6A. In this case, it is assumed that the circumferential width Eg of each of the end portions E1 and E2 in the groove portion 502 is substantially equal to that En of each of protruding end convex portions Et1 and Et2 in the non-groove portion 504. The lubricant 28 lying in the radial space portion is scraped up in the end portions E1 and E2 in the groove portion 502 and guided toward the intermediate portion P by the relative rotation between the cylinder portion inner circumferential surface 16a of the sleeve 16 and the outer circumferential surface 22c of the shaft 22. The guided lubricant 28 generates the dynamic pressure acting on the shaft 22 by running on the center convex portion Pt in the non-groove portion 504, near the intermediate portion P. In this case, as the circumferential width Pn of the center convex portion Pt becomes large, the circumferential distance in which the running-on lubricant 28 acts as radial dynamic pressure becomes long. As a result, the radial stiffness can be increased with the radial dynamic pressure efficiently acting on the shaft 22.

For example, when the diameter of the second radial dynamic pressure generating portion RB is 4 mm, the number of the groove portions 502 per circumference can be twelve. Further, the present inventors have confirmed from experiments that the radial dynamic pressure groove can be processed such that: the circumferential width Eg of each of the end portions E1 and E2 in the groove portion 502 and the circumferential width En of each of the end convex portions Et1 and Et2 are approximately 0.52 mm; the circumferential width Pg of the intermediate portion P in the groove portion 502 is approximately 0.26 mm; and the circumferential width Pn of the center convex portion Pt in the non-groove portion 504 is approximately 0.79 mm. The inventors have also confirmed from experiments that successful radial dynamic pressure can be generated by forming such a radial dynamic pressure groove.

Alternatively, when the diameter of the second radial dynamic pressure generating portion RB is, for example, 3 mm, the number of the groove portions 502 per circumference can be eight. Further, the present inventors have confirmed from experiments that the radial dynamic pressure groove can be processed such that: the circumferential width Eg of each the end portions E1 and E2 in the groove portion 502 and that En of each of the end convex portions Et1 and Et2 are approximately 0.59 mm; the circumferential width Pg of the intermediate portion P in the groove portion 502 is approximately 0.29 mm; and the circumferential width Pn of the center convex portion Pt is approximately 0.89 mm. The inventors have also confirmed from experiments that successful radial dynamic pressure can be generated by forming such a radial dynamic pressure groove.

Alternatively, when the diameter of the second radial dynamic pressure generating portion RB is, for example, 2.5 mm, the number of the groove portions 502 per circumference can be eight. Further, the present inventors have confirmed from experiments that the radial dynamic pressure groove can be processed such that: the circumferential width Eg of each of the end portions E1 and E2 in the groove portion 502 and that En of each of the end convex portions Et1 and Et2 are approximately 0.49 mm; the circumferential width Pg of the intermediate portion P in the groove portion 502 is approximately 0.25 mm; and the circumferential width Pn of the center convex portion Pt is 0.73 mm. The inventors have also confirmed from experiments that successful radial dynamic pressure can be generated by forming such a radial dynamic pressure groove.

Alternatively, when the diameter of the second radial dynamic pressure generating portion RB is 2.0 mm, the number of the groove portions 502 per circumference can be six. Further, the present inventors have confirmed from experiments that the radial dynamic pressure groove can be processed such that: the circumferential width Eg of each of the end portions E1 and E2 in the groove portion 502 and the circumferential width En of each of the end convex portions Et1 and Et2 are approximately 0.52 mm; the circumferential width Pg of the intermediate portion P in the groove portion 502 is approximately 0.26 mm; and the circumferential width Pn of the non-groove portion is approximately 0.79 mm. The inventors have also confirmed from experiments that successful radial dynamic pressure can be generated by forming such a radial dynamic pressure groove.

Further, the present inventors have confirmed from experiments that successful radial dynamic pressure effects can be created by making the ratio Pn/Pg of the circumferential width Pn of the non-groove portion 504 to that Pg of the groove portion 502 greater than or equal to 1.2; and the radial dynamic pressure groove can be easily processed by making the ratio Pn/Pg smaller than or equal to 5.

FIG. 6B is an illustrative view illustrating another shape of the radial dynamic pressure groove. In the case of this example, the circumferential width of at least one of the end portions in the groove portion 502 is made larger than that of the non-groove portion 504. FIG. 6B illustrates the case where the circumferential width Eg of each of the end portions E1 and E2 in the groove portion 502 is larger than that En of each of the end convex portion Et1 and Et2, and the circumferential width Pg of the intermediate portion P in the groove portion 502 is approximately equal to that Pn of the center convex portion Pt. A larger amount of the lubricant 28 can be scraped up by making the circumferential width Eg of each of the end portions E1 and E2 in the groove portion 502 large. With this, a large amount of the lubricant 28 run on the center convex portion Pt in the non-groove portion 504, near the intermediate portion P, so that the lubricant 28 acts as dynamic pressure. As a result, the radial stiffness can be increased with the dynamic pressure efficiently acting on the shaft 22. Also, in this example, the present inventors have confirmed from experiments that successful dynamic pressure effects can be created by making the ratio Eg/En of the circumferential width Eg of each of the end portions E1 and E2 in the groove portion 502 to that En of each of the end convex portions Et1 and Et2 greater than or equal to 1.2, and the radial dynamic pressure groove can be easily processed by making the ratio Eg/En smaller than or equal to 5.

FIG. 6C is an illustrative view illustrating another shape of the radial dynamic pressure groove. In the case of this example, the circumferential width Eg of each of the end portions E1 and E2 in the groove portion 502 is made larger than that En of each of the end convex portions Et1 and Et2, and the circumferential width Pn of the center convex portion Pt is made larger than that Pg of the intermediate portion P in the groove portion 502. In this case, a large amount of the lubricant 28 can be scraped up because the circumferential width Eg of each of the end portions E1 and E2 in the groove portion 502 is large. Further, because the circumferential width Pn of the center convex portion Pt is large, the circumferential distance in which the running—on lubricant 28 acts as dynamic pressure becomes long. As a result, the radial stiffness can be further increased with the radial dynamic pressure efficiently acting on the shaft 22. Also, in this example, the present inventors have confirmed from experiments that successful radial dynamic pressure can be generated by making Pn·Eg/(Pg·En) greater than or equal to 1.4, and the radial dynamic pressure groove can be easily processed by making Pn·Eg/(Pg·En) smaller than or equal to 25.

When a radial dynamic pressure groove is formed by ball-rolling, it is difficult to partially make the circumferential width of the groove portion large. Then, the present inventors have found that a desired shape can be obtained by forming a radial dynamic pressure groove with cutting. For example, the main body of the sleeve 16 is at first formed by cutting or resin molding (sleeve main body formation step), and then a groove is formed by contacting the tip of a cutting bite with the inside of the cylinder portion inner circumferential surface 16a of the sleeve 16 while rotating the sleeve 16 that is chucked with a lathe (striped pattern formation step). At the time, the tip of the cutting bite is driven in the radial direction with a piezoelectric element. A groove is formed when driving the tip of the cutting bite outwards in the radial direction. A groove is not formed when driving the tip of the cutting bite inwards in the radial direction. A groove with a desired shape can be formed by repeating these drives in accordance with the rotation of the sleeve 16. A radial dynamic pressure groove as illustrated in FIGS. 6A to 6C can be processed with such cutting processing, thereby allowing for an increase in radial dynamic pressure and an increase in the bearing stiffness to be easily realized.

Each of the shapes of the radial dynamic pressure grooves illustrated in FIGS. 3 and 6A to 6B represents only one example; and similar effects can be obtained so long as a radial dynamic pressure groove is composed of a plurality of striped groove portions repeatedly arranged along the rotational direction and the groove portion has a shape in which the lubricant 28 scraped up in its end portions is collected into the intermediate portion. Although FIGS. 3 and 6A to 6B illustrate herringborn shapes in which the groove portions are formed linearly; however, a herringborn shape including a curved portion or a herringborn shape in which a straight line and a curved line are combined, can be adopted.

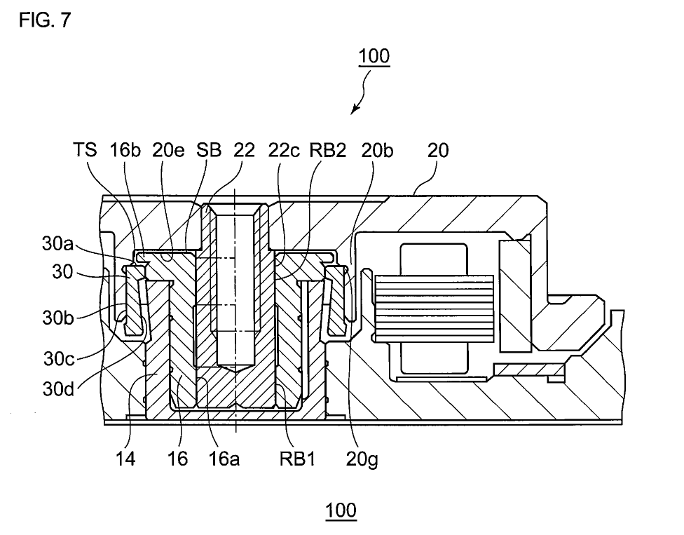

Subsequently, a variation of the disk drive device 100 will be described by using the partially enlarged cross-sectional view of the vicinity of the bearing illustrated in FIG. 7. In FIG. 2, an example in which the thrust member 26 is composed of the flange 26e and the hanging portion 26c has been described. On the other hand, in the variation illustrated in FIG. 7, a thrust member 30 is composed of only a hanging portions 30b. Although such a hanging portion 30b may be referred to as a flange, the portion will be described herein as a hanging portion 30b. It is noted that, in FIG. 7, members common to those in FIG. 2, etc., are denoted with the same reference numerals and the descriptions thereof will be omitted. In each of a first radial dynamic pressure generating portion RB1 and a second radial dynamic pressure generating portion RB2, a radial space portion is formed by the outer circumferential surface 22c of a shaft 22 and the cylinder portion inner circumferential surface 16a of a sleeve 16 in the same way as the structure in FIG. 2. For example, a herringborn-shaped radial dynamic pressure groove for generating radial dynamic pressure is formed on at least one of the outer circumferential surface 22c and the cylinder portion inner circumferential surface 16a. On the other hand, a thrust dynamic pressure generating portion SB is formed in the axial gap between the lower surface 20e of a hub 20 and the upper surface of a circumferentially-protruding portion 16b of the sleeve 16. That is, for example, a spiral-shaped thrust dynamic pressure groove (not illustrated) for generating thrust dynamic pressure is formed on the lower surface 20e and the upper surface of the circumferentially-protruding portion 16b, the two surfaces facing each other.

The thrust member 30 includes an upper end portion 30a, the hanging portion 30b, an outer circumferential surface 30c, and an inner circumferential surface 30d. That is, the thrust member 30 does not include the flange 26e in FIG. 2 and forms an approximately ring shape only with the hanging portion 30b corresponding to the hanging portion 26c. The upper end portion 30a faces the lower surface of the circumferentially-protruding portion 16b of the sleeve 16 via a narrow gap and fulfills the function of preventing coming-off. The outer circumferential surface 30c of the hanging portion 30b is fixed to the inner circumferential surface of a first cylinder portion 20b of the hub 20. When fixed with adhesive, adhesion strength may be improved and protrusion of the adhesive may be prevented by providing a concave portion 20g, as illustrated in FIG. 7, on the inner circumferential surface of the first cylinder portion 20b of the hub 20, the concave portion serving as a reservoir portion for the adhesive.

A capillary seal portion TS is composed of the outer circumferential surface of a member composing a fixed body S, such as the sleeve 16 and a housing 14, etc., (hereinafter, referred to as the “fixed body outer circumferential surface”) and the inner circumferential surfaces 30d of the hanging portion 30b of the thrust member 30. The radial size (the size in the horizontal direction of the drawing) of the thrust member 30 is made as short as 0.3 to 0.5 mm such that the space in the radial direction is not uselessly occupied and the sizes of the bearing portion and a stator core portion can be made large. On the other hand, the axial size (the size in the vertical direction of the drawing) of the thrust member is made as long as 1.5 to 3.0 mm such that the capacity of the capillary seal portion TS on the inner circumferential surface is made large.

Also, in the structure of the disk drive device 100 illustrated in FIG. 7, the embodiments described with reference to FIGS. 2 to 5 and 6A to 6B can be applied, which can provide similar effects. Further, in the examples of the FIGS. 2 and 7, the descriptions have been made assuming that the sleeve 16 and the housing 14 are formed as different members; however, similar effects can be obtained when the two are formed integrally with each other.

The present invention shall not be limited to the aforementioned embodiments, and various modifications, such as design modifications, can be made with respect to the above embodiments based on the knowledge of those skilled in the art. The structure illustrated in each drawing is intended to exemplify an example, and the structure can be appropriately modified to a structure having a similar function, which can provide similar effects.

What is claimed is:

1. A disk drive device comprising:
a hub on which a recording disk is to be mounted;
a shaft to be the rotational center of the hub;
a sleeve configured to house the shaft and to be rotatable relatively with respect to the shaft;
a radial space portion formed between the inner circumferential surface of the sleeve and the outer circumferential surface of the shaft;
a radial dynamic pressure generating portion configured to generate radial dynamic pressure between at least part of the inner circumferential surface of the sleeve and the outer circumferential surface of the shaft in the radial space portion; and
lubricant injected into the radial dynamic pressure generating portion, wherein the axial length of the radial dynamic pressure generating portion is structured to be longer than the diameter of the radial dynamic pressure generating portion such that radial dynamic pressure, which is defined with the axial length of the radial dynamic pressure generating portion and the diameter thereof being parameters, is greater than or equal to a predetermined minimum reference value.

2. The disk drive device according to claim 1, wherein the radial dynamic pressure generating portion has individual radial dynamic pressure generating portions separated into at least two in the axial direction, and wherein the axial length of the individual radial dynamic pressure generating portion formed near to the hub is longer than that of the individual radial dynamic pressure generating portion formed away from the hub.

3. The disk drive device according to claim 1, wherein the axial length of the radial dynamic pressure generating portion in the radial space portion is longer than that of a non-radial dynamic pressure generating portion in the radial space portion.

4. The disk drive device according to claim 1 further comprising:
a tubular housing member arranged so as to surround the sleeve and to make one end of the sleeve protrude; and
a tubular thrust member that is fixed to the hub to rotate integrally with the hub, wherein the thrust member has a hanging portion surrounding the housing member to rotate outside the housing member, and wherein the lubricant lies between the outer circumferential surface of the housing member and the inner circumferential surface of the hanging portion, and wherein
the length where the outer circumferential surface of the housing member and the inner circumferential surface of the hanging portion face each other is longer than the axial length of the hub located on the line extended in the axial direction from the outer circumferential surface of the housing member.

5. The disk drive device according to claim 4, wherein the length where the outer circumferential surface of the housing member and the inner circumferential surface of the hanging portion face each other is longer than the length of a non-radial dynamic pressure generating portion in the radial space portion.

6. The disk drive device according to claim 4, wherein the surface roughness of at least one of the outer circumferential surface of the housing member and the inner circumferential surface of the hanging portion, the two surfaces facing each other, is larger than that of the outer circumferential surface of the shaft.

7. The disk drive device according to claim 4, wherein at least one of the outer circumferential surface of the housing member and the inner circumferential surface of the hanging portion, the two surfaces facing each other, is subjected to a hydrophilic treatment.

8. The disk drive device according to claim 4, wherein a lubricant moving portion in which the lubricant is forced to move inwards from the open end between the outer circumferential surface of the housing member and the inner circumferential surface of the hanging portion with the rotation of the hub, is formed on at least one of the outer circumferential surface and the inner circumferential surface, the two surfaces facing each other.

9. The disk drive device according to claim 8, wherein the lubricant moving portion is a groove portion formed in the circumferential direction on the two surfaces, the two surfaces facing each other.

10. The disk drive device according to claim 4, wherein the gas-liquid interface of the lubricant at rest, the lubricant lying between the outer circumferential surface of the housing member and the inner circumferential surface of the hanging portion, is located at the position corresponding to the axial center of an area where the outer circumferential surface of the housing member and the inner circumferential surface of the hanging portion face each other.

11. The disk drive device according to claim 4, wherein the hub comprises a center hole to which the shaft is fixed, and a first cylinder portion formed outside the center hole, to which the hanging portion is fixed, and wherein the center hole and the inner circumferential surface of the first cylinder portion are formed by continuously being processed so as to be substantially concentric with each other.

12. The disk drive device according to claim 11, wherein the hub comprises a second cylinder portion formed outside the first cylinder portion, the second cylinder portion being engaged with the center hole of the recording disk, and wherein the inner circumferential surface of the first cylinder portion and the outer circumferential surface of the second cylinder portion are formed by continuously being processed so as to be substantially concentric with each other.

13. The disk drive device according to claim 1, wherein the radial dynamic pressure generating portion is composed of a plurality of striped groove portions repeatedly arranged along the rotational direction, and wherein each of the striped groove portions is formed by end portions on both sides and an intermediate portion sandwiched by the end portions on both sides, and the end portions on both sides and the intermediate portion are arranged such that the lubricant is collected into the intermediate portion by the relative rotation between the shaft and the sleeve, and wherein the width in the rotational direction of the intermediate portion in the striped groove portion is narrower than that in the rotational direction of each of the end portions on both sides.

14. A disk drive device comprising:
a hub on which a recording disk is to be mounted;
a shaft to be the rotational center of the hub;
a sleeve configured to house the shaft and to be rotatable relatively with respect to the shaft;
a radial space portion formed between the inner circumferential surface of the sleeve and the outer circumferential surface of the shaft;
a radial dynamic pressure generating portion configured to generate radial dynamic pressure between at least part of the inner circumferential surface of the sleeve and the outer circumferential surface of the shaft in the radial space portion; and
lubricant injected into the radial dynamic pressure generating portion, wherein the radial dynamic pressure generating portion is composed of a plurality of striped groove portions repeatedly arranged along the rotational direction, and wherein each of the striped groove portions is formed by end portions on both side and an intermediate portion sandwiched by the end portions on both sides, and the end portions on both sides and the intermediate portion are arranged such that the lubricant is collected into the intermediate portion by the relative rotation between the shaft and the sleeve, and wherein the width in the rotational direction of the intermediate portion in the striped groove portion is narrower than that in the rotational direction of each of the end portions on both sides.

15. The disk drive device according to claim 14, wherein the width in the rotational direction of the intermediate portion in the striped groove portion is narrower than that in the rotational direction of a center convex portion in a non-groove formation area adjacent to the striped groove portion, the center convex portion corresponding to the intermediate portion in the striped groove portion.

16. The disk drive device according to claim 14, wherein the width in the rotational direction of each of the end portions in the striped groove portion is larger than that in the rotational direction of an end convex portion in a non-groove formation area adjacent to the striped groove portion, the end convex portion corresponding to the end portion in the striped groove portion.

17. A method of manufacturing a sleeve in the disk drive device of claim 14, the method comprising:
a sleeve main body formation step in which the main body of the sleeve is formed; and
a striped pattern formation step in which a striped groove portion is formed by cutting.

18. The method of manufacturing a disk drive device according to claim 17, wherein, in the striped pattern formation step, the striped groove portion is formed by contacting the tip of a cutting bite with the inside of the inner circumferential surface of the cylinder portion of the sleeve while rotating the sleeve that is chucked with a lathe.

19. The method of manufacturing a disk drive device according to claim 18, wherein, in the striped pattern formation step, the striped groove portion is formed when driving the tip of the cutting bite outwards in the radial direction with a piezoelectric element, and the striped groove portion is not formed when driving the tip of the cutting bite inwards in the radial direction.

20. The method of manufacturing a disk drive device according to claim 19, wherein, in the striped pattern formation step, the drives of the cutting bite are repeatedly performed in accordance with the rotation of the sleeve.
